(19) United States
(12) Patent Application Publication
(10) Pub. No.: US 2005/0201848 A1
(43) Pub. Date: Sep. 15, 2005

(54) Bolt assembly

(76) Inventor: Leonora Megna Reilly, Mebane, NC (US)

Correspondence Address: Jennifer M. Brumbaugh, 3300 University Drive, Auburn Hills, MI, 48326-2362, US

(21) Appl. No.: 11/076,301

(22) Filed: Mar. 9, 2005

Related U.S. Application Data
(60) Provisional application No. 60/552,462, filed on Mar. 12, 2004.

(51) Int. Cl. F16B 21/18

(52) U.S. Cl. 411/353

(57) ABSTRACT

A bolt suitable for connecting two structures is disclosed. The bolt includes a head and a shaft and a detent positioned about at least a portion of the shaft of the bolt. The detent may be adapted to interface with a sidewall of an aperture of a structure to substantially retain the bolt in a pre-assembly position.

### RELATED APPLICATION

This application claims the benefit of U.S. Provisional Patent Application No. 60/552,462, filed Mar. 12, 2004.

### BACKGROUND

It is known in the art to use a bolt to connect one structure to another. For example a bolt may be used to connect a propshaft to a joint, including, without limitation, a constant velocity joint within a drivetrain system. To increase efficiency and output in a manufacturing environment, the bolt, the joint and the shaft may be pre-configured for more rapid assembly. For example, the bolt may be pre-positioned in an aperture of a first structure such that a push on the pre-positioned bolt engages a complementary aperture of a second structure to substantially effectuate proper positioning or placement.

One conventional technique to retain the bolt in the aperture of the first structure utilizes a liquid material disposed over at least a portion of the bolt to form part of a ring therearound, or, alternatively, spread over the entire bolt. The liquid material is then hardened to secure the bolt to the aperture of the first structure. As the liquid material sets, it may become brittle and subsequently dislodge from the bolt or the first structure. Thus, slight movements of the bolt or first structure thereafter, such as vibrations resulting from normal movement or jarring, may result in the bolt being removed from the first structure or lost. Such slight movements, for example, among others, may occur during transportation of the shaft or joint to the assembly plant.

One technique to address this problem is to add additional liquid material to the interface between the bolt and the aperture of the first structure. However, this added liquid material may sometimes lead to the bolt becoming stuck or lodged within the aperture, and not capable of being manually pushed into the proper position so that the bolt and the connected structures are properly aligned to facilitate engagement. In this instance, the bolt may need forcible movement to properly dislodge the bolt. The forcible movement may require the use of an additional tool, including, without limitation, a hammer, a screwdriver, a wrench or the like. Such an added step may increase the assembly time of the unit, and thereby negate at least some of the benefits from the pre-placement or pre-positioning of the bolt assembly.

Thus, there is a need in the art for a bolt assembly that is capable of being retained in a temporary position during transfer of the bolt assembly and provides for easier installation of the associated assembly.

### SUMMARY

Accordingly, an embodiment of the invention is directed to a bolt suitable for connecting two structures. The bolt includes a head, a shaft, and a detent positioned about at least a portion of the shaft of the bolt. The detent may be adapted to interface with a sidewall of an aperture of a structure to substantially retain the bolt in a pre-assembly position.

Other systems, methods, features, and advantages of the invention will be or become apparent to one with skill in the art upon examination of the following drawings and detailed description. It is intended that all such additional systems, methods, features, and advantages be included within this description, be within the scope of the invention, and be protected by the accompanying claims.

### BRIEF DESCRIPTION OF THE DRAWINGS

FIG. 1 is a perspective view of a bolt assembly according to an embodiment of the invention;

FIG. 2 is a perspective view of a bolt assembly according to an embodiment of the invention;

FIG. 3 is a side view of a bolt assembly of the type shown in FIG. 2;

FIG. 4 is a top view of a bolt assembly of the type shown in FIG. 2;

FIG. 5 is a perspective view of a driveshaft according to an embodiment of the invention;

FIG. 6 is a side view of a driveshaft of the type shown in FIG. 5; and

FIG. 7 is an exploded view of a portion of the driveshaft arrangement shown in FIG. 6.

### DETAILED DESCRIPTION

With general reference to the Figures, exemplary bolt-washer assemblies are shown in accordance with various embodiments of the invention. A bolt-washer assembly may be used in many suitable environments; however, for purpose of explanation the present disclosure will discuss the bolt-washer assembly for use in a vehicular application. Specifically, the present disclosure discusses the utilization of a bolt-washer assembly to provide a connection mechanism between a propshaft and a coupling assembly with a drivetrain. It is noted, however, that the discussed bolt-washer assemblies may also be used in other vehicular applications including, without limitation, constant velocity joints, flanges, half-shafts, coupling, differentials, transfer cases, transmissions or any other connecting device known for use in a vehicle. Moreover, the bolt-washer assembly may be used outside of the noted vehicular applications. Thus, the invention should not be limited to such vehicular applications and this feature will become readily apparent to one of ordinary skill in the art when considering the present disclosure.

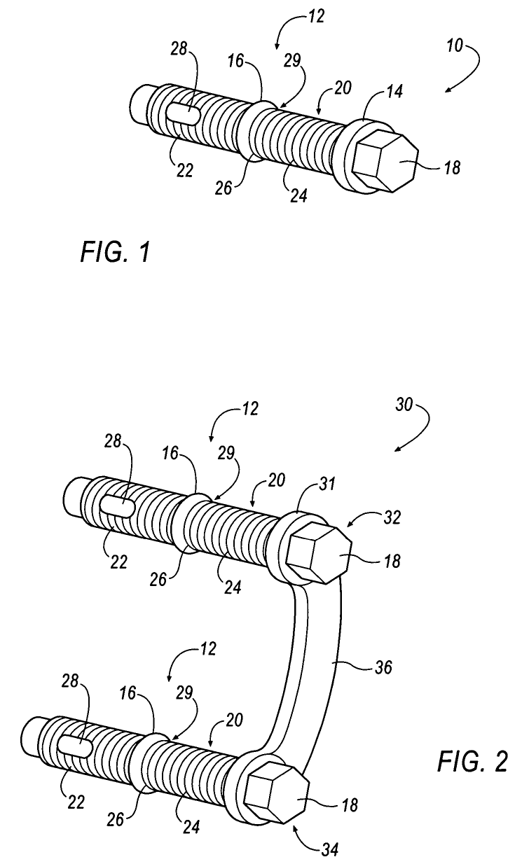

Referring now to FIG. 1, an assembly 10 is shown in accordance with an embodiment of the invention. The assembly 10 includes a bolt 12, a washer 14, and a detent 16. Although the disclosure herein provides a specific arrangement of the bolt 12, washer 14 and detent 16, additional possible combinations will be readily recognized by persons of ordinary skill on the art after reading the present disclosure, and, therefore, the invention should not be limited to the exemplary embodiments disclosed herein. Also, the combination of the bolt 12 and the detent 16 provide an inventive combination and this inventive combination should not be limited to articles that include a washer 14, although some assemblies that include a washer 14 may include further inventive aspects.

The bolt 12 includes a head 18 and a shaft 20. The shaft 20 includes a first portion 22, a second portion 24 and a central portion 26 positioned between the first and second portions 22, 24. The Figures illustrate that the first portion 22 and the second portion 24 may include a plurality of threads thereon. It should be noted, however, that the invention contemplates that any thread arrangement or configuration may be used, and one of ordinary skill will realize that for some applications only one of the first portion 22, the second portion 24 and the central portion 26 may include threads. Moreover, for some embodiments, none of the portions 22, 24 and 26 may include threading. In addition, the direction, alignment and spacing of the threads should not be limited to the illustrated thread arrangement, as one of ordinary sill in the art may readily modify the thread arrangement to fit a particular application. The principles of the invention herein do not depend on a specific thread arrangement or configuration, and, therefore the invention should not be limited as such.

With reference to the Figures, the bolt 12 may further include a thread lock 28, which may be positioned at an end of the bolt 12 (e.g., the end more remote from the head 18), to further secure the bolt 12 upon final assembly. For example, a cotter pin or the like may be positioned through the thread lock 28 to further secure the bolt. In the illustrated embodiments, the thread lock is shown as an oval recess. However, the thread lock 28 may instead take on any variety of shapes or forms or formations as are known to those of skill in the art. It should further be noted that the invention may not include a thread lock, or may integrate an alternate thread lock to the type illustrated. Such a use, absence, or alternate use of a thread lock will be readily recognized by one of ordinary skill after consulting the present disclosure.

The detent 16 may be integrally formed as a part of the bolt 12 (i.e. formed integrally therewith as a single or unitary component) or it may be a separate piece that is connected to a bolt after the manufacturing of the other portions of a bolt 16. In the latter case, the detent may take the form of an o-ring wherein the central portion 26 of the bolt 14 may define a groove 29 or other formation to seat or otherwise retain the detent, for example, so that the detent 16 does not undesirably slide in any direction on or across the shaft 20 of the bolt 12. In another embodiment, the central portion 26 is threadless and the first and second portion 22, 24 include threads. In this type of embodiment, the threads may be configured to define a seat or retaining formation for the detent 16. It should be noted, however, that such a seat or other retaining formation is not a necessary feature of the invention, and, therefore, the invention may be practiced without such a seat or retaining formation. For example, the detent 16 may provide sufficiently elastic surface contact to “grip” the shaft 20 so as to substantially prevent undesirable movement of the detent 16 along the shaft 20.

In an embodiment, the detent 16 is composed of a material having at least a minimal degree of elasticity and friction. One such material is rubber. It should be noted, however, that many materials other than rubber might be suitable for use in various embodiments of the invention. Such materials include, without limitation, nylon, plastic, elastomers, fabric and the like. In an embodiment, the detent 16 may be composed of nitrile rubber.

Although the Figures illustrate the head 20 of the bolt 12 as having a generally hexagonal shape, the head 20 may be formed in a wide variety of shapes and sizes. In an embodiment, the head 20 of the bolt 12 may be hexagonal and can be adapted to engage a corresponding wrench to apply a torque to the bolt 12. However, other suitable bolt head configurations or structures are known and such configurations or structures will generally be known and may be used. For some embodiments of the invention, however, the bolt 12 may not rely on added torque and the head 20 of the bolt 12 may not include such a function or feature.

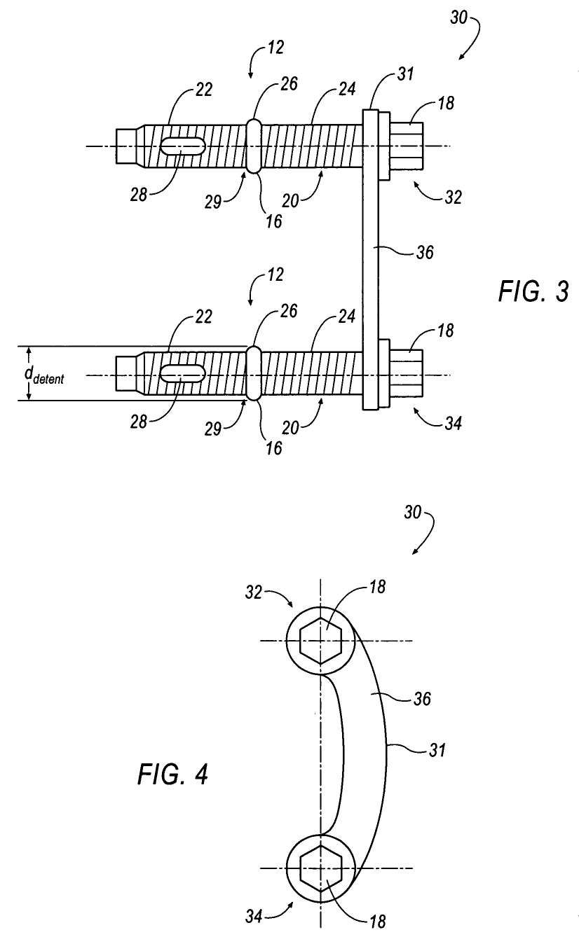

Referring now to FIGS. 2 through 4, another example of an assembly 30 is shown. In this embodiment, a washer 31 includes a first end 32, a second end 34, and a central portion 36 positioned between the first and second ends 32,34. The first and second ends 32, 34 each include sidewalls that may define an aperture for at least two bolts 12 to pass therethrough. In the illustrated embodiment, the central portion 36 of the washer 14 forms an arcuate shape. However, as readily recognized by one or ordinary skill in the art, the size and shape of the washer 14 may be modified to meet the needs of an intended application. For example, for some embodiments, the shape of at least one side or portion of the washer 36 can be configured to mirror or otherwise interface with a corresponding side or portion of a structure (e.g., a structural component of a vehicle).

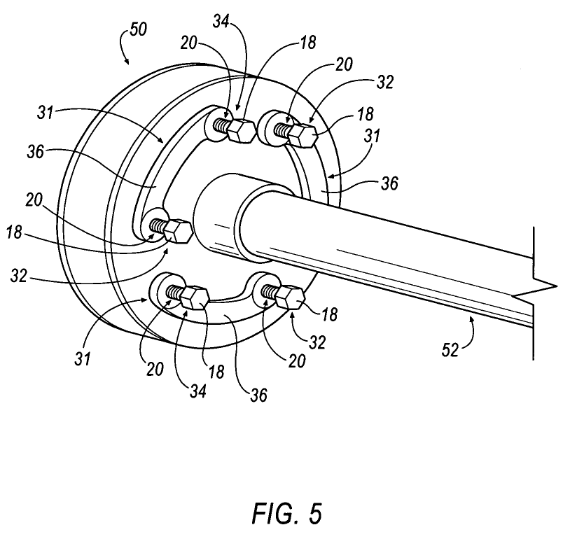

Referring now to FIGS. 5 through 7, three bolt-washer assemblies 30 (such as the exemplary assemblies illustrated in FIGS. 2 through 4) are shown pre-positioned with respect to a coupling 50 of a propshaft 52. As illustrated, the washer 31 may include a side or portion with an arcuate shape. For some embodiments, portions of the washer may be shaped to help provide a mechanism for connecting the coupling 50 of a propshaft 52 to another structure. In the illustrated embodiment shown in FIG. 5, each washer 31 has at least two curved surfaces or edges, i.e., a curved surface or edge that is closer to the center of the shaft and a curved surface or edge that is farther from the center of the shaft. While not a required limitation, the illustrated washers are shown spaced substantially equidistant from a center point (which generally corresponds to the centerline of the illustrated shaft). It should be noted that other bolt assembly configurations, particularly variants of the washer size and shape may be used to adequately provide this structure including, without limitation, the bolt washer assembly from FIG. 1. Thus, the invention is not limited by size and shape of the washer, or the position and/or number of apertures associated with a specific washer or set of washers. Thus, the invention should not be so limited.

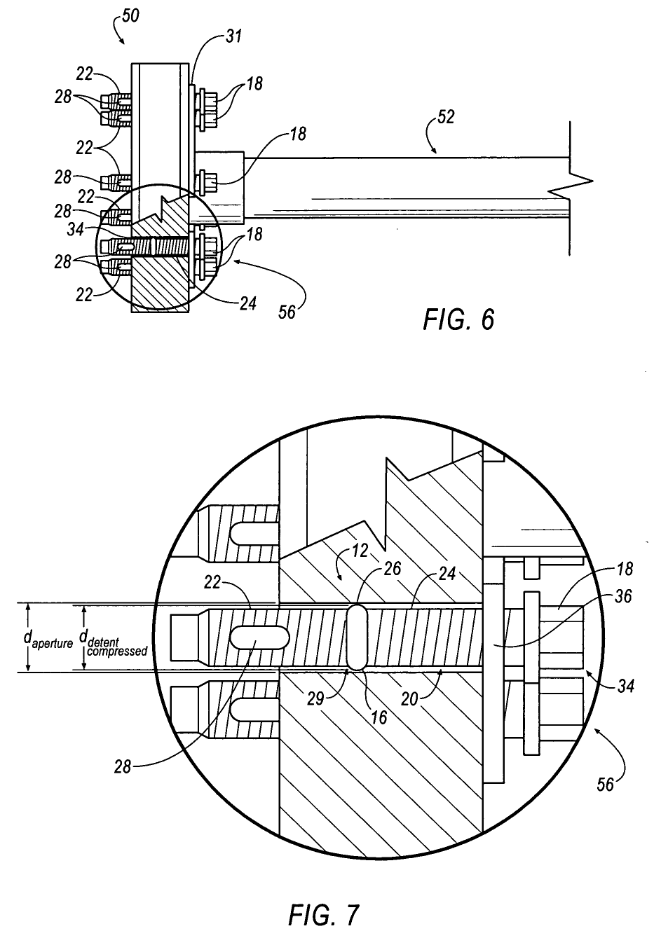

With continued reference to FIGS. 6 and 7, a side view of a propshaft 52, coupling 50, and a bolt-washer assembly 30 is illustrated. The illustration highlights a possible interface between detent 16 of the bolt 12 as it resides within and at least temporarily engages a portion of coupling 50. That is, the coupling 50 includes at least one aperture 56. FIG. 7 illustrates an embodiment wherein the aperture 56 has a diameter dₐₚₑᵣₜᵤᵣₑ. In an embodiment, the detent 16 has a diameter d_{detent} (i.e., prior to insertion into the aperture) and d_{detent compressed} (i.e., after insertion into the aperture). That is, dₐₚₑᵣₜᵤᵣₑ is smaller or equal to d_{detent} such that when the detent compresses, a radial retaining force is applied between the detent 16 and the associated sidewalls of the aperture 56. In an embodiment, at least one factor to consider in determining an appropriate size difference is the elasticity of the material of the detent. This feature should be readily recognized by one of ordinary skill after consulting the present disclosure. Thus, as the detent 16 interfaces with the sides of the aperture 56, the surfaces thereof engage one another to provide at least temporary support to retain or hold the bolt 12 in a pre-assembly position within the associated structure.

In the exemplary application illustrated, bolts 12 are pre-arranged and are generally held in place in a pre-assembly position within the coupling 50 associated with a propshaft 52 prior to connection thereof to another structure or component, for example, a component or structure associated with a drivetrain. Such pre-assemblies provide a mechanism for two structures to be more quickly connected or attached because the associated bolts 12 are already housed with respect to the proper apertures 56 in the first structure (e.g. a coupling 50). Thus, the process is advanced by, among other things, the pre-positioning of the bolts 12 in their associated aperture 56. In an embodiment, a corresponding structure, such as a component of a drivetrain, can then be quickly aligned with the pre-placed bolts. After this, a pressure (e.g., a manual force) may be applied to the bolts 12 to move them further into an aperture or other receiving member of a second structure or component, and, if desired, a torque may be subsequently or contemporaneously applied to the head 20 of the bolt 12.

The assembly provided includes, among other things, an improved method of holding or retaining the bolt 12 in place during transportation of components to an assembly plant. However, the invention is not limited to a specific number of bolts and/or the corresponding arrangement and positioning as shown and described in the exemplary embodiments. In an embodiment, the number, arrangement, and position of a bolt or bolts may depend, in part, on the torque being transferred therewith, and the axial forces that are inherent to the environment. Therefore, in an embodiment, the use of bolts to connect components to one another at least effectively addresses the axial forces of such systems. Such novel arrangements will be readily apparent to one of ordinary skill after consulting the present disclosure.

Also, in a pre-assembly format, the bolt 12 may, if desired, be configured to extend a predetermined distance beyond the end of the structure to which the assembly is connected. The predetermined distance may, to some degree, depend on the application. In a manufacturing environment, the extensions of the bolt 12 beyond a predetermined distance may, among other things, provide structure to index the bolt 12, for example, by running one's hand along the surface. Once the structures become properly aligned, a longitudinal force may be applied to the bolt 12 until the end of the bolt 12 moves into engagement with an aperture or other receiving formation associated with the structure being connected to the assembly. In an embodiment, the aperture or receiving formation of the structure being connected may be threaded, and a torque may be applied to the bolt 12 to seat at least a portion of a threaded section of the bolt 12.

It should be noted that the bolt 12 could be made of any type of metal, hard ceramic, hard plastic, compositions or any other known material. However, for some environments (e.g., a drivetrain environment) certain factors including, among others, torque, axial forces and temperature may limit the selection of material.

It should also be understood that various alternatives to and adaptations of the specific embodiments of the invention described herein might be employed in practicing the invention. It is intended that the following claims define the scope of the invention and that practices of methods and apparatus within the scope of these claims and their equivalents be covered thereby.

1. An assembly suitable for connecting two structures, said assembly comprising:
a bolt having a head and a shaft;
a detent positioned about at least a portion of said shaft of said bolt; and
a first structure including an aperture;
wherein said detent is adapted to interface with a sidewall of said aperture of said first structure to substantially retain said bolt in a pre-assembly position.

2. The assembly as in claim 1, wherein said detent has a first diameter and the aperture of said first structure has a second diameter, and said first diameter is greater than or equal to the second diameter.

3. The assembly as in claim 1, wherein said shaft includes a first portion, a second portion, and a central portion between said first and second portion, and further wherein said detent is positioned over at least a portion of said central portion.

4. The assembly as in claim 3, wherein said central portion defines a formation to position or retain said detent.

5. The assembly as in claim 3, wherein at least one of said first portion and said second portion includes threads.

6. The assembly as in claim 5, wherein both said first portion and said second portion include threads.

7. The assembly as in claim 6, wherein said threads of said first portion and said second portion form a seating formation for said detent in said central portion.

8. The assembly as in claim 1, wherein said shaft further includes a thread lock.

9. The assembly as in claim 1, wherein said detent and said bolt are integrally formed as a unitary component.

10. The assembly as in claim 1, further comprising a washer having an aperture for receiving said bolt.

11. The assembly as in claim 1, wherein said washer includes a first end and a second end, and wherein each of said ends includes an aperture for receiving an associated bolt.

12. The assembly as in claim 11, wherein a portion of said washer has an arcuate shape.

13. The assembly as in claim 10, wherein a shape of a portion of said washer substantially matches a shape of a portion of a formation associated with said first structure.

14. A bolt suitable for connecting a first structure to a second structure, said bolt comprising:
a base having a head and a shaft;
a detent positioned about a portion of said shaft,
wherein said detent is adapted to interface with a sidewall of an aperture of the first structure to substantially retain said bolt in a pre-assembly position prior to assembly of the first structure and the second structure.

15. The bolt as in claim 14, wherein said detent has a first diameter and the aperture of the first structure has a second diameter, and further wherein said first diameter is greater than or equal to the second diameter.

16. The bolt as in claim 14, wherein said shaft includes a first portion, a second portion, and a central portion between said first and second portions, and further wherein said detent is positioned about at least a portion of said central portion.

17. The bolt as in claim 16, wherein said central portion defines a formation or groove to position or retain said detent.

18. The bolt as in claim 16, wherein at least one of said first portion and said second portion includes threads.

19. The bolt as in claim 18, wherein both said first portion and said second portion include threads.

20. The bolt as in claim 19, wherein said threads of said first portion and said second portion form a seating formation for said detent in said central portion.

21. The bolt as in claim 14, wherein said shaft includes a thread lock.

22. The bolt as in claim 14, wherein said detent and said bolt are integrally formed as a unitary component.

23. A method for forming a bolt assembly comprising:
providing a bolt having a detent positioned about at least a portion of a shaft;
providing a first structure including an aperture; and
inserting the shaft of the bolt into the aperture of the first structure such that the detent engages a sidewall of the aperture to at least temporarily retain the bolt in a pre-assembly position.

24. The method as in claim 23 further comprising:
providing a second structure including a recess or formation, wherein the recess or formation is adapted to receive the bolt;
aligning the recess or formation of the second structure with the aperture of the first structure;
supplying force to the bolt such that a portion of the bolt moves into the recess or formation of the second structure.

25. The method as in claim 24 further comprising:
securing said bolt to the second structure.
